(19) United States
(12) Patent Application Publication
(10) Pub. No.: US 2024/0416742 A1
(43) Pub. Date: Dec. 19, 2024

(54) TRANSFORMATION OF MOTOR LAND VEHICLES INTO ELECTRIC VEHICLES BY CHANGING TIRES

(71) Applicant: Tuzunoglu Kalip Sanayi Ve Ticaret A.S., Zeytinburnu/Istanbul (TR)

(72) Inventors: Ethem TUZUNOGLU, Zeytinburnu/Istanbul (TR); Kerem TUZUNOGLU, Zeytinburnu/Istanbul (TR)

(73) Assignee: Tuzunoglu Kalip Sanayi Ve Ticaret A.S., Zeytinburnu/Istanbul (TR)

(21) Appl. No.: 18/705,612

(22) PCT Filed: Dec. 29, 2022
(86) PCT No.: PCT/TR2022/051695

§ 371 Date: Apr. 29, 2024

(30) Foreign Application Priority Data
Mar. 21, 2022 (TR) 2022/004283

(51) Int. Cl. B60K 7/00

(52) U.S. Cl. CPC B60K 7/0007; B60K 2007/0038; B60K 2007/0092

(57) ABSTRACT

This invention relates to the conversion of motor land vehicles into electric vehicles by changing tires and consists of rim system (1), bolt holes (2), tire (3), flange (4), inner surface of rim (5), anchor (6), copper winding (7), anchor holes (8), magnet (9), motor driver and communication circuit board (10), battery (11), battery box (12), ccs female socket (13), ac female socket input (14), dc female socket input (15), control screen (16), ac male socket input (17), domestic converter (18), adapter (19), mains plug (20), resonance preventive balls (21), engine isolation cover (22), engine wedge (23), connection arm (24), spring (25) and battery boxes external connections (26).

This invention relates to the conversion of motor land vehicles into electric vehicles by changing tires and consists of rim system, bolt holes, tire, flange, inner surface of rim, anchor, copper winding, anchor holes, magnet, motor driver and communication circuit board, battery, battery box, ccs female socket, ac female socket input, dc female socket input, control screen, ac male socket input, domestic converter, adapter, mains plug, resonance preventive balls, engine isolation cover, engine wedge, connection arm, spring and battery boxes external connections.

The invention relates to the conversion of internal combustion engine vehicles into electric vehicles by changing their tires.

### STATE OF THE ART

Electric car is the name given to cars powered by electricity. An electric car is a car that is driven using one or more electric motors, using electricity stored in batteries and other energy storage devices. With the development of electric car technologies, it is seen that it will have an important place in the automotive industry in the future. Electric cars work with electric motors that share similar principles with the motors found in the washing machine, and these motors have 3 main advantages over the internal combustion engines found in fuel oil cars: efficiency, wear-free, bidirectional operation. Even the most efficient of internal combustion engines can convert only 30-35% of the energy it consumes as a result of combustion, moving parts and drive-train into motion. However, this rate is 90% in electric motors. While the remaining energy in other motors is released as heat, vibration and sound, electric motors do not produce much sound or heat due to their efficiency. In addition, it is predicted that this type of cars will reduce urban pollution and reduce carbon dioxide emissions, as well as saving fuel. The degree of reduction in carbon dioxide emissions depends on electricity generation and is expected to be 30%.

In the field of electric cars, conversion processes into electric vehicles have been tried by placing an outboard motor in the interior of the vehicle. However, in these systems, the connection and integration of the vehicle's chassis is a problem in itself. The design of each vehicle is different, since there is not enough space in most vehicles, the vehicle was completely disassembled and the volume was opened for the electric motor, or it was integrated in a way that would cause problems in long-term use.

Therefore, such designs are not suitable for mass production. For this reason, it was not preferred by consumers. In addition, if it is desired to attach the motors that are closed up to the hub to the rim, the existing mechanical systems must be cut and processed in order to remove the brake systems of the vehicle and attach the rim system to the vehicle.

### Benefits of the Invention

Although the invention is a technique that eliminates all the disadvantages in existing systems, since there is no engine removal process during the conversion to electric vehicles, the existing fuel system can be activated in case the vehicle runs out of charge on the road. Thus, even when vehicle charging stations are not widespread, it will not be possible to stay on the road. In the case of use with fuel, the vehicle can charge itself during this period, and after a certain period of time, it can be returned to electrical energy.

The invention is completely consumer friendly. It can only be attached and removed from the vehicle like an accessory. The transformation will be completed by changing the tire, completing the system integration and adding a battery to the vehicle, without damaging the existing system of the vehicle owner. Thus, it can be produced in accordance with mass production and can be installed in harmony with every vehicle.

The most important benefit provided by the invention is that it can be made electrically operated without damaging applications such as cutting and disassembling the main part of the vehicle, since standard rim sizes are not exceeded.

### Application Method of the Invention

The rim system (1) provides rotational movement with the inner surface of the rim (5) and transmits the energy it receives from the batteries (11) to the system after the stationary stator part of the engine are mounted to the static evening of the vehicle with the flange (4), making it possible to drive easily. Since the inner surface of the rim (5) is a movable mechanism, if the system does not take the energy from the batteries (11), when another rotational energy is given from the outside (when the vehicle runs on fuel energy), the batteries (11) will recharge itself by storing energy. While the charging process takes place by means of a domestic converter (18) attached to the house, it will be able to be charged during travel with the charging stations located in the vicinity, by means of both the ac female socket input (14) and the dc female socket input (15). Therefore, the ccs female socket (13) will be fitted in standard sizes. In places where there is no charging station, charging can be completed by means of the adapter (19) by plugging the AC male socket socket (17) into the mains by means of the mains plug (20) in places where charging is desired. In order to prevent the rim system (1) from being damaged against sudden loads from the external environment, resonance preventive balls (21) are used. In order for the engine to work for a long time in a clean environment and to keep it away from dust or foreign substances, the engine insulation cover (22) is used. While the rim system (1) transfers the rotational motion of the engine to the vehicle, the engine wedge (23) is used so that it can move freely. In order to connect this rim system (1) to the vehicle, the connection rod (24) is used. A spring (25) has been added to the system to prevent the connection rod (24) from being subjected to sudden stresses. The battery boxes (12), which are designed as add-on for the motor to travel longer distances, can be made by means of external connections (26). The motor driver and communication circuit board (10) is placed to provide the movement and transfer the necessary data to the control screen (16). The connection of the rim system (1) will be easily completed by tightening the bolt holes (2) with the bolts, such as when changing a winter tire. The outdoor housing of the batteries (11) will be realised with the battery box (12). What provides the rotational energy to the rim system (1) is the magnetic field formed by the magnet (9) of the copper windings (7), which are connected to the flange (4) through the anchor holes (8) and wrapped around the anchor (6). The system that receives the rotational energy will be able to provide movement on the contacting surface by means of the tire (3).

The system realised to achieve the purpose of the invention has been shaped in the attached figures, these figures are;

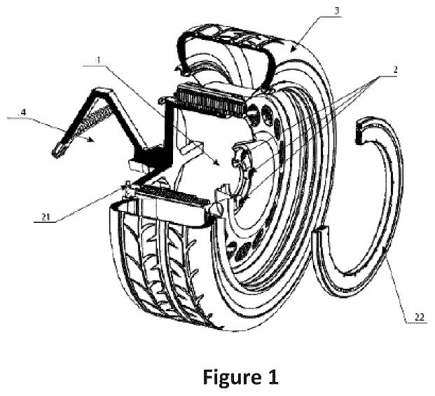

FIG. 1—Tire and rim system image of transforming motor vehicles into electric vehicles by changing tires

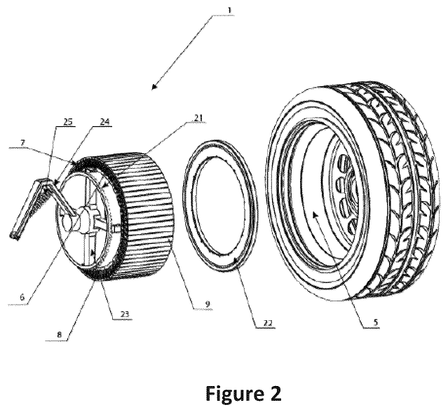

FIG. 2—Conversion of motor vehicles to electric vehicles by changing tires, inner surface of rim system flange and the rim

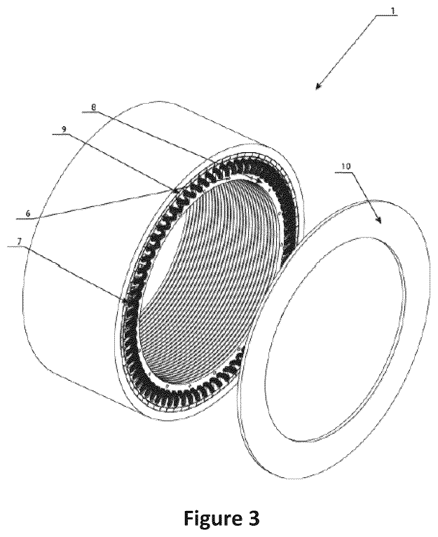

FIG. 3—Conversion of motor vehicles to electric vehicles by changing tires, image of rim system and engine driver and communication circuit board

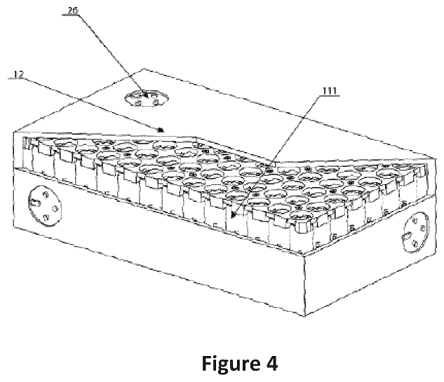

FIG. 4—Battery and box image of the conversion system of motor vehicles to electric vehicles by changing tires

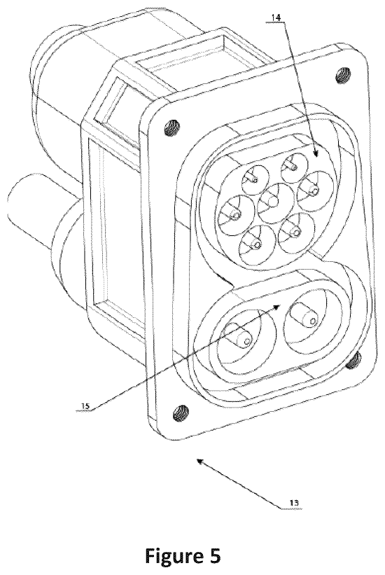

FIG. 5—Female socket inputs of the conversion system of motor vehicles to electric vehicles by changing tires

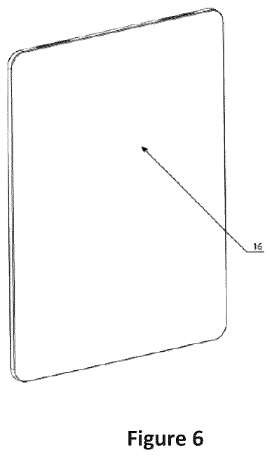

FIG. 6—Control screen of conversion of motor land vehicles to electric vehicles by changing tires

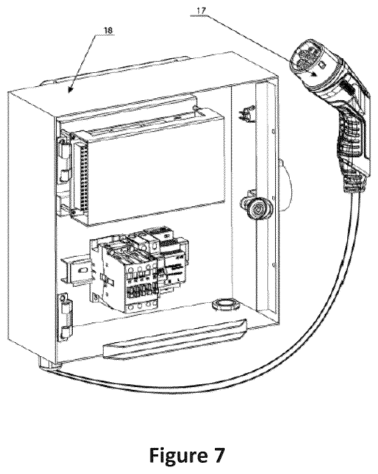

FIG. 7—Male socket input and domestic converter image of the conversion system of motor land vehicles to electric vehicle by changing tires

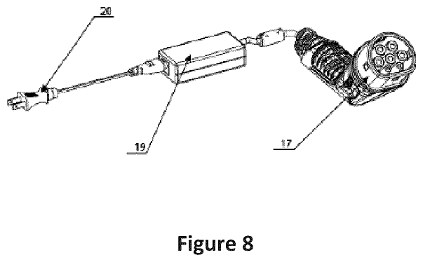

FIG. 8—Adapter, male socket inlet and mains plug of the conversion system of motor vehicles to electric vehicles by changing tires

The numbers in the figures are numbered and shown below.
1. Rim system
2. Bolt holes
3. Tire
4. Flange
5. Rim inner surface
6. Anchor
7. Copper winding
8. Anchor holes
9. Magnet
10. Engine driver and communication circuit board
11. Battery
12. Battery box
13. Css female socket
14. Ac female socket input
15. Dc female socket input
16. Control screen
17. Ac male socket input
18. Domestic converter
19. Adapter
20. Mains plug
21. Resonance preventive balls
22. Engine isolation cover
23. Engine wedge
24. Connection arm
25. Spring
26. Battery boxes external connections

This invention relates to the conversion of motor land vehicles into electric vehicles by changing tires and consists of rim system (1), bolt holes (2), tire (3), flange (4), inner surface of rim (5), anchor (6), copper winding (7), anchor holes (8), magnet (9), motor driver and communication circuit board (10), battery (11), battery box (12), ccs female socket (13), ac female socket input (14), dc female socket input (15), control screen (16), ac male socket input (17), domestic converter (18), adapter (19), mains plug (20), resonance preventive balls (21), engine isolation cover (22), engine wedge (23), connection arm (24), spring (25) and battery boxes external connections (26).

1. Conversion of motor land vehicles into electric vehicles by changing tires, wherein the system consists of rim system (1), bolt holes (2), tire (3), flange (4), inner surface of rim (5), anchor (6), copper winding (7), anchor holes (8), magnet (9), motor driver and communication circuit board (10), battery (11), battery box (12), ccs female socket (13), ac female socket input (14), dc female socket input (15), control screen (16), ac male socket input (17), domestic converter (18), adapter (19), mains plug (20), resonance preventive balls (21), engine isolation cover (22), engine wedge (23), connection arm (24), spring (25) and battery boxes external connections (26) parts.

2. Conversion of motor land vehicles into electric vehicles by changing tires according to claim 1, comprising the rim system (1) that provides the rotational movement of the wheel.

3. Conversion of motor land vehicles into electric vehicles by changing tires according to claim 1, comprising bolt holes (2) that allow the rim to be attached to the vehicle.

4. Conversion of motor land vehicles into electric vehicles by changing tires according to claim 1, comprising the tire (3) that makes contact with the ground so that the vehicle can travel while driving.

5. Conversion of motor land vehicles into electric vehicles by changing tires according to claim 1, comprising flange (4) for fixing the motor stator to the stationary part of the vehicle.

6. Conversion of motor land vehicles into electric vehicles by changing tires according to claim 1, comprising rim inner surface (5) providing rotational movement.

7. Conversion of motor land vehicles into electric vehicles by changing tires according to claim 1, comprising anchor (6) that enables the copper wires to be wrapped on it.

8. Conversion of motor land vehicles into electric vehicles by changing tires according to claim 1, comprising copper winding (7) acting on the magnetic field.

9. Conversion of motor land vehicles into electric vehicles by changing tires according to claim 1, comprising the anchor holes (8) for fixing the anchor (6).

10. Conversion of motor land vehicles into electric vehicles by changing tires according to claim 1, comprising magnet (9) that enables affecting the magnetic field of the copper windings (7).

11. Conversion of motor land vehicles into electric vehicles by changing tires according to claim 1, comprising engine driver and communication circuit board (10) that makes the engine turn.

12. Conversion of motor land vehicles into electric vehicles by changing tires according to claim 1, comprising engine driver and communication circuit board (10) that communicates with the notification screen.

13. Conversion of motor land vehicles into electric vehicles by changing tires according to claim 1, comprising battery (11) for energy storage.

14. Conversion of motor land vehicles into electric vehicles by changing tires according to claim 1, comprising battery box (12) that provides isolation of the batteries (11) from the external environment.

15. Conversion of motor land vehicles into electric vehicles by changing tires according to claim 1, comprising ccs female socket for charging the vehicle (13).

16. Conversion of motor land vehicles into electric vehicles by changing tires according to claim 1, comprising ac female socket input (14) that allows the vehicle to be charged with alternating current.

17. Conversion of motor land vehicles into electric vehicles by changing tires according to claim 1, comprising dc female socket input (15) that enables the allows to be charged with direct current.

18. Conversion of motor land vehicles into electric vehicles by changing tires according to claim 1, comprising control screen (16) that provides control and notification of the vehicle.

19. Conversion of motor land vehicles into electric vehicles by changing tires according to claim 1, comprising ac male socket input (17) that allows the converted electricity to enter the vehicle appropriately.

20. Conversion of motor land vehicles into electric vehicles by changing tires according to claim 1, comprising domestic converter (18) which is the electrical panel section where the mains voltage is adjusted.

21. Conversion of motor land vehicles into electric vehicles by changing tires according to claim 1, comprising adapter (19) for adjusting the mains voltage.

22. Conversion of motor land vehicles into electric vehicles by changing tires according to claim 1, comprising mains plug (20) suitable for domestic mains voltages.

23. Conversion of motor land vehicles into electric vehicles by changing tires according to claim 1, comprising resonance preventive balls (21) that reduce the loads applied to the engine by sudden forces during driving.

24. Conversion of motor land vehicles into electric vehicles by changing tires according to claim 1, comprising engine insulation cover (22) that prevents dust or foreign matter from entering the engine.

25. Conversion of motor land vehicles into electric vehicles by changing tires according to claim 1, comprising engine wedge (23) that prevents the tire from restricting the oscillating motion of the tire while transmitting the rotational motion of the engine.

26. Conversion of motor land vehicles into electric vehicles by changing tires according to claim 1, comprising connection arm (24) for providing a static connection between the engine and the vehicle.

27. Conversion of motor land vehicles into electric vehicles by changing tires according to claim 1, comprising spring (25) for reducing the load of the static joint.

28. Conversion of motor land vehicles into electric vehicles by changing tires according to claim 1, comprising battery boxes external connections (26) for increasing range and adding extra batteries.
